(19) United States
(12) Patent Application Publication
(10) Pub. No.: US 2018/0096246 A1
(43) Pub. Date: Apr. 5, 2018

(54) INFORMATION PROCESSING DEVICE AND INFORMATION PROCESSING METHOD

(71) Applicant: Oki Electric Industry Co., Ltd., Tokyo (JP)

(72) Inventors: Kohei YAMAMOTO, Tokyo (JP); Kurato MAENO, Tokyo (JP)

(73) Assignee: Oki Electric Industry Co., Ltd., Tokyo (JP)

(21) Appl. No.: 15/615,872

(22) Filed: Jun. 7, 2017

(30) Foreign Application Priority Data
Sep. 30, 2016 (JP) 2016-192482

(51) Int. Cl. G06N 3/08

(52) U.S. Cl. CPC G06N 3/08

(57) ABSTRACT

To reduce a network size and calculation cost with regard to a neural network to which multidimensional data is input.

Provided is an information processing device including: an estimation unit configured to estimate a status by using a neural network constituted by single- or multi-dimensional neurons that perform output on the basis of input multidimensional data. The neural network includes a transformation layer configured to transform output of a type 1 neuron into a dimension corresponding to input of a type 2 neuron, and the type 2 neuron performs a process based on lower-dimensional data than the type 1 neuron.

### CROSS REFERENCE TO RELATED APPLICATION(S)

This application is based upon and claims benefit of priority from Japanese Patent Application No. 2016-192482, filed on Sep. 30, 2016, the entire contents of which are incorporated herein by reference.

### BACKGROUND

The present invention relates to information processing devices and information processing methods.

In recent years, neural networks have been focused on. The neural networks are mathematical models that simulate a cerebral nervous system. In addition, devices that use the neural network to perform various kinds of identification have been developed. For example, JP 2016-75558A discloses a radar signal processing device that uses a neural network and estimates the number of preceding vehicles from phase difference between reception signal vectors obtained from an array antenna.

### SUMMARY

However, according to the technology described in JP 2016-75558A, an upper triangular matrix excluding diagonal components of an autocorrelation matrix of the reception signal vector is input to a real- or complex-valued neural network. Therefore, according to the technology described in JP 2016-75558A, it is necessary to input all possible combination pairs corresponding to the number of elements of the reception signal vector, and the size of the neural network tends to get larger.

In addition, the technology described in JP 2016-75558A has a problem of increase in calculation cost for combination arithmetic of the number of elements.

Accordingly, it is desirable to provide a system capable of reducing a network size and calculation cost with regard to a neural network to which multidimensional data is input.

According to an aspect of the present invention, there is provided an information processing device including: an estimation unit configured to estimate a status by using a neural network constituted by single- or multi-dimensional neurons that perform output on the basis of input multidimensional data. The neural network includes a transformation layer configured to transform output of a type 1 neuron into a dimension corresponding to input of a type 2 neuron. The type 2 neuron performs a process based on lower-dimensional data than the type 1 neuron.

The type 1 neuron may be a complex-valued neuron, and the type 2 neuron may be a real-valued neuron.

The neural network may further include a complex-valued network constituted by at least one or more layers including an input layer to which complex data is input, and a real-valued network constituted by at least one or more layers including an output layer to which real data is input. The transformation layer may connect the complex-valued network and the real-valued network.

The transformation layer may propagate error information in the real-valued network backward to the complex-valued network.

The transformation layer may divide output of the complex-valued neuron on the basis of a real part and an imaginary part, and transform the output into a dimension corresponding to input of the real-valued neuron.

The transformation layer may divide output of the complex-valued neuron on the basis of phase and amplitude, and transform the output into a dimension corresponding to input of the real-valued neuron.

On the basis of a sine wave and a cosine wave, the transformation layer may further divide the output of the real-valued neuron that has been divided on the basis of phase, and transform the output into a dimension corresponding to input of the real-valued neuron.

The transformation layer may decide the number of the real-valued neurons on the basis of phase.

According to an aspect of the present invention, there is provided an information processing method using a neural network constituted by single- or multi-dimensional neurons to which multidimensional data is input, the information processing method including transforming output of a type 1 neuron into a dimension corresponding to input of a type 2 neuron. In the transformation, the type 2 neuron performs a process based on lower-dimensional data than the type 1 neuron.

As described above, according to the present invention, it is possible to reduce a network size and calculation cost with regard to a neural network to which multidimensional data is input.

### BRIEF DESCRIPTION OF THE DRAWINGS

FIG. 1 is a diagram illustrating a configuration example of a neural network according to an embodiment of the present invention,

FIG. 2 is a diagram illustrating connection relation in a conventional real-valued neural network,

FIG. 3 is a diagram illustrating connection relation in a conventional complex-valued neural network,

FIG. 4 is a functional block diagram of an information processing device according to the embodiment,

FIG. 5A is an explanatory diagram illustrating the backward propagation of errors based on Wirtinger derivatives according to the embodiment,

FIG. 5B is an explanatory diagram illustrating the backward propagation of errors based on Wirtinger derivatives according to the embodiment,

FIG. 6 is an explanatory diagram illustrating transformation of input/output of neurons on the basis of a real-part/imaginary-part method according to the embodiment,

FIG. 7 is an explanatory diagram illustrating transformation of input/output of neurons on the basis of an amplitude/phase method according to the embodiment,

FIG. 8 is an explanatory diagram illustrating transformation of input/output of neurons on the basis of a combined method according to the embodiment,

FIG. 9 is an explanatory diagram illustrating transformation of input/output of neurons on the basis of an N-division phase method according to the embodiment,

FIG. 10 is a diagram illustrating an example of a region divided on the basis of an N-division phase method according to the embodiment,

FIG. 11 is an explanatory diagram illustrating transformation of input/output of a hypercomplex-valued neuron according to the embodiment,

FIG. 12 is an explanatory diagram illustrating a full connection pattern according to the embodiment,

FIG. 13 is an explanatory diagram illustrating a separate connection pattern according to the embodiment,

FIG. 14 is an explanatory diagram illustrating a partial and separate connection pattern according to the embodiment,

FIG. 15 is a diagram illustrating a configuration of a comparative real-valued neural network according to the embodiment,

FIG. 16 is a diagram illustrating a result of phase difference learning using a conventional real-valued neural network according to the embodiment,

FIG. 17 is a diagram illustrating a result of phase difference learning using a neural network according to the embodiment, and

FIG. 18 is a hardware configuration example of an information processing device according to the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. First Embodiment

### <<1.1. Summary of First Embodiment>>

In recent years, various neural network models have been proposed with development of information processing technologies. Some of the neural network models perform identification on the basis of input multidimensional data such as a complex number or a quaternion.

On the other hand, as described above, a way to solve the problem of increase in a network size or calculation cost of neural networks to which multidimensional data is input has been desired.

The information processing device and the information processing method according to an embodiment of the present invention have been made in view of the above described problem. According to the embodiment of the present invention, it is possible to perform accurate estimation while reducing a network size and calculation cost of a neural network to which multidimensional data is input. As one of the features of the neural net model according to the embodiment, the neural net model includes a transformation layer configured to transform output of a type 1 neuron into a dimension corresponding to input of a type 2 neuron. The type 2 neuron may perform a process based on lower-dimensional data than the type 1 neuron.

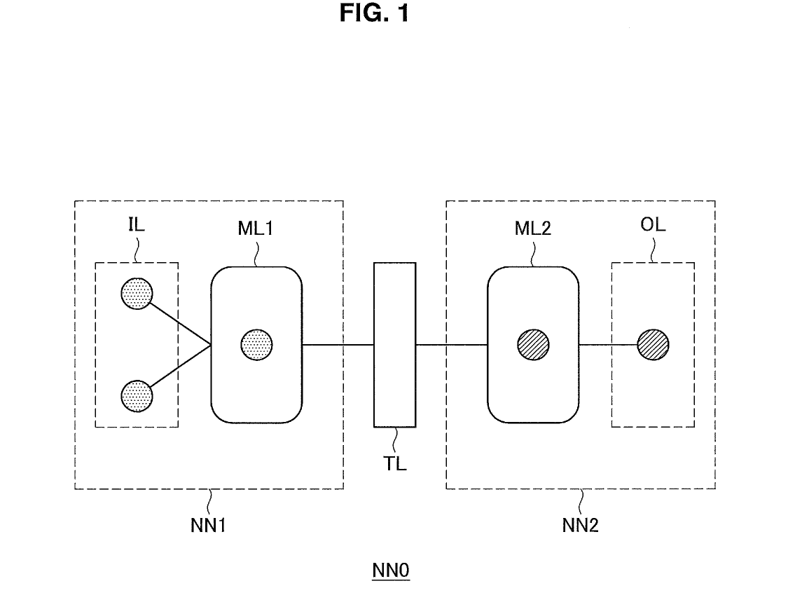

FIG. 1 is a diagram illustrating a configuration example of a neural network NN0 according to the embodiment. With reference to FIG. 1, the neural network NN0 according to the embodiment includes a type 1 neural network NN1, a transformation layer TL, and a type 2 neural network NN2.

The multidimensional data according to the embodiment means data from which one or more observation values can be obtained with regard to one observation target. For example, observation values including a point in an x-y-z coordinate system are multidimensional data having three dimensions. Hereinafter, a dimension of input or output of a neuron means a dimension of a multidimensional neuron. The multidimensional neuron is a neuron associated with a piece of multidimensional data. For example, a neuron associated with a point in an x-y coordinate system that is a complex plane (multidimensional data having two dimensions) is a multidimensional neuron (complex-valued neuron).

In addition, the multidimensional data has the same dimension as a dimension of input of the multidimensional neuron. In general, each layer in a neural network is constituted by a plurality of neurons. Therefore, a plurality of multidimensional neurons constitutes one layer, and an output value of this layer is multidimensional data with regard to the plurality of multidimensional neurons. In this case, the number of neurons in the respective layers may be the same or may be different from each other in the neural network constituted by the plurality of layers.

The layers may be fully connected, or may be locally connected such as a convolutional neural network (CNN). In general, each connection has a weight in a neural network, and an output value of a neuron becomes input of a neuron in a next layer via the weighted connection. In this case, the weight has the same number of dimensions as the multidimensional neuron, and the number of dimensions of the neurons in the adjacent layers are the same. When an input data array of the multidimensional data is assumed to be an input layer of the multidimensional neurons, each of the plurality of the multidimensional neurons in the input layer has multidimensional data as an input value of the neural network, and the input layer is connected with a next layer having the same number of dimensions via multidimensional connection.

### (Type 1 Neural Network NN1)

The type 1 neural network NN1 according to the embodiment may be a neural network to which multidimensional data is input. In addition, the type 1 neural network NN1 according to the embodiment performs a process based on higher-dimensional data than the type 2 neural network NN2. For example, the type 1 neural network NN1 according to the embodiment may be a complex-valued neural network that performs a process based on a complex number, or may be a quaternion neural network that performs a process based on a quaternion. Alternatively, the type 1 neural network NN1 according to the embodiment may be a neural network that performs any arithmetic process between pieces of data in different dimensions on a neuron having two or more dimensions.

Hereinafter, a case where the type 1 neural network NN1 according to the embodiment is a complex-valued neural network will be described as an example. In other words, the type 1 neural network NN1 according to the embodiment may be a complex-valued network constituted by at least one or more layers including an input layer to which complex data is input.

With reference to FIG. 1, the type 1 neural network NN1 according to the embodiment includes an input layer IL and a middle layer ML1. In this case, all processes such as input, connection weighting, and output may be defined by complex numbers in the input layer IL and the middle layer ML1. In the example illustrated in FIG. 1, type 1 neurons (complex-valued neurons) in the input layer ML and the middle layer ML1 are hatched with dots.

### (Transformation Layer TL)

The transformation layer TL according to the embodiment has a function of connecting the type 1 neural network NN1 and the type 2 neural network NN2. The transformation layer TL according to the embodiment also has a function of transforming output of a type 1 neuron in the type 1 neural network into a dimension corresponding to input of a type 2 neuron in the type 2 neural network NN2. For example, the transformation layer TL according to the embodiment may transform a complex-valued neuron into a real-valued neuron. Details of the functions of the transformation layer TL according to the embodiment will be described later.

### (Type 2 Neural Network NN2)

The type 2 neural network NN2 according to the embodiment performs a process based on lower-dimensional data than the type 1 neural network NN1. For example, in the case where the type 1 neural network NN1 is a complex-valued neural network, the type 2 neural network NN2 according to the embodiment may be a real-valued neural network.

Hereinafter, a case where the type 2 neural network NN2 according to the embodiment is a real-valued neural network will be described as an example. In other words, the type 2 neural network NN2 according to the embodiment may be a real-valued network constituted by at least one or more layers including an output layer to which real data is input.

With reference to FIG. 1, the type 2 neural network NN2 according to the embodiment includes a middle layer ML2 and an output layer OL. In this case, all processes such as input, connection weighting, and output may be defined by real numbers in the middle layer ML2 and the output layer OL. In the example illustrated in FIG. 1, type 2 neurons (real-valued neurons) in the middle layer ML2 and the output layer OL are hatched with solid lines.

The configuration example of the neural network NN0 according to the embodiment has been described above. As described above, the neural network NN0 according to the embodiment includes the complex-valued type 1 neural network NN1, the transformation layer TL, and the real-valued type 2 neural network NN2. For example, the transformation layer TL according to the embodiment also has a function of transforming output of the complex-valued type 1 neuron into a dimension correspond to input of the real-valued type 2 neuron.

By using the neural network NN0 according to the embodiment, the above described combination pairs do not have to be input, and it is possible to directly input multidimensional data such as a complex number. This enables a large reduction in the network size and calculation cost.

In addition, by using the neural network NN0 according to the embodiment, it is expected to improve estimation accuracy more than a case of using a conventional complex-valued neural network or a conventional real-valued neural network alone.

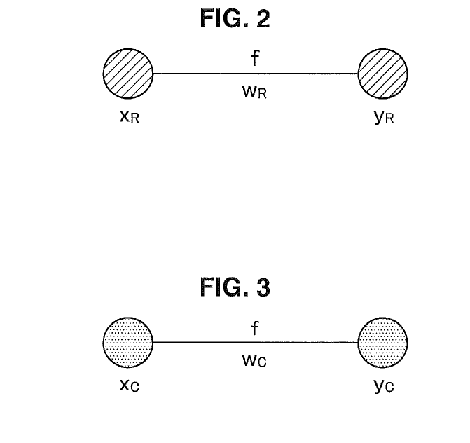

FIG. 2 is a diagram illustrating connection relation in a conventional real-valued neural network. As illustrated in FIG. 2, input x_{R}, a connection weight w_{R}, and output y_{R} in the real-valued neural network are all defined by real numbers. That is, the connection relation in the real-valued neural network may be represented by the following equation (1). In FIG. 2 and the following equation (1), R may represent a real number.

y_{R}=f(w_{R}x_{R})∈Rⁿ (1)

Therefore, complex data cannot be directly input to the real-valued neural network, and a process to extract a real number from the complex data in advance is necessary.

On the other hand, FIG. 3 is a diagram illustrating connection relation in a conventional complex-valued neural network. As illustrated in FIG. 3, input x_{C}, a connection weight w_{C}, and output y_{C} in the complex-valued neural network are all defined by complex numbers. That is, the connection relation in the complex-valued neural network may be represented by the following equation (2). In FIG. 3 and the following equation (2), C may represent a complex number.

y_{C}=f(w_{C}x_{C})∈Cⁿ (2)

Therefore, the complex-valued neural network is excellent in the case of a process of inputting complex data. The complex data may be data in which significance is attached to the size of waves such as radio waves or acoustic waves or significance is attached to phase lead/lag, or data in which significance is attached to a specific direction such as a wind direction, for example. However, in the complex-valued neural network, output is also a complex data. Therefore, real data such as phase difference cannot be directly output. Accordingly, in the case where return to a real number is performed in the complex-valued neural network as described above, it is necessary to make some kind of contraption such as previously making a rule to determine which real number a value of vibration or phase of output corresponds to.

In addition, according to the above described method, a real number is used for data that should not be actually represented by the real number. Therefore, it is difficult to take into account phase wraparound such as 0 to 2π, amplitude positivity, or the like, and this results in decrease in accuracy.

On the other hand, the neural network NN0 according to the embodiment can avoid the decrease in accuracy since the neural network NN0 according to the embodiment includes the transformation layer TL configured to transform output of a complex-valued neuron into a dimension corresponding to input of a real-valued neuron. Details of the functions of the transformation layer TL according to the embodiment will be described later.

The summary of the neural network NN0 according to the embodiment has been described above. The case where the neural network NN0 includes one transformation layer TL and two neural networks constituted by the type 1 neural network and the type 2 neural network has been described above as an example. Alternatively, the neural network NN0 according to the embodiment may include three or more types of neural networks and two or more transformation layers. Next, a case where the type 1 neural network NN1 is a complex-valued neural network and the type 2 neural network NN2 is a real-valued neural network will be described as an example. However, the configuration of the neural network NN0 according to the embodiment is not limited thereto. For example, the type 1 neural network NN1 according to the embodiment may be a quaternion neural network. The configuration of the neural network NN0 according to the embodiment can be flexibly changed by properties of data to be used.

### <<1.2. Functional Configuration of Information Processing Device 10>>

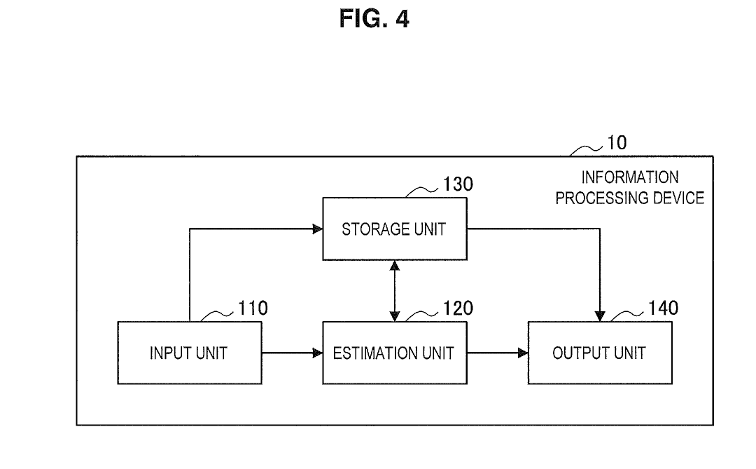

Next, a functional configuration of an information processing device 10 according to the embodiment will be described. FIG. 4 is a functional block diagram of the information processing device 10 according to the embodiment. With reference to FIG. 4, the information processing device 10 according to the embodiment includes an input unit 110, an estimation unit 120, a storage unit 130, and an output unit 140. Hereinafter, the configuration will be described while focusing on functions of the configuration.

### (Input Unit 110)

The input unit 110 has a function of detecting various kinds of operation performed by an operator. For example, the input unit 110 according to the embodiment may detect input operation performed by the operator for designating data to be used by the estimation unit 120 (to be described later) for estimation. Therefore, the input unit 110 according to the embodiment may include various devices configured to detect input operation performed by an operator. For example, the input unit 110 may be implemented by various buttons, a keyboard, a touch screen, a mouse, a switch, or the like.

### (Estimation Unit 120)

The estimation unit 120 has a function of estimating a status on the basis of a machine learning model by using input multidimensional data. Therefore, the estimation unit 120 according to the embodiment may include the above described neural network NN0. For example, the estimation unit 120 according to the embodiment may estimate phase difference between two signals on the basis of input complex data.

### (Storage Unit 130)

The storage unit 130 has a function of storing programs, data, and the like that are used in respective structural elements of the information processing device 10. For example, the storage unit 130 according to the embodiment may store various parameters used for the neural network NN0 included in the estimation unit 120, an output result output from the estimation unit 120, and the like.

### (Output Unit 140)

The output unit 140 has a function of outputting various kinds of information to an operator. For example, the output unit 140 according to the embodiment may output an estimation result estimated by the estimation unit 120. Therefore, the output unit 140 according to the embodiment may include a display device configured to output visual information. For example, the display unit may be implemented by a cathode ray tube (CRT) display device, a liquid crystal display (LCD) device, an organic light emitting diode (OLED) device, a touchscreen, a projector, or the like.

The functional configuration example of the information processing device 10 according to the embodiment has been described. The above described functional configuration example is a mere example, and the functional configuration example of the information processing device 10 according to the embodiment is not limited thereto. The information processing device 10 according to the embodiment may further include a structural element other than the structural elements illustrated in FIG. 4. For example, the information processing device 10 may further include a communication unit configured to communicate information to another information processing terminal, or the like. The functional configuration of an information processing device 10 according to the embodiment can be flexibly modified.

### <<1.3. Transformation of Input/Output of Neuron Via Transformation Layer TL>>

Next, details of transformation of input/output of a neuron via the transformation layer TL according to the embodiment will be described. As described above, the transformation layer TL according to the embodiment has a function of transforming output of a complex-valued neuron in the type 1 neural network NN1 into a dimension corresponding to input of a real-valued neuron in the type 2 neural network NN2. In this case, in order to improve accuracy of the estimation, it is important to propagate information output from the type 1 neural network NN1 forward to the type 2 neural network NN2 as much as possible without losing the information.

In addition, in this case, it is desirable to select transformation methods in accordance with properties of input data so as to minimize the information loss. For example, in a case where input complex data is interpreted on the basis of a real part component and an imaginary part component, an extracted real number may be an index that indicates how close to a real axis and an imaginary axis. Specifically, in a case where the input complex data is data in which significance is attached to a direction such as a wind direction or an air volume, it is expected to minimize information loss by performing transformation based on a real part and an imaginary part.

Alternatively, for example, in a case where complex data is interpreted on the basis of an amplitude component and a phase component, an extracted real number may be an index that indicates magnitude and a direction of a rotation component. Specifically, in a case where the input complex data is data in which significance is not attached to a specific phase direction such as radio wave data, it is expected to minimize information loss by performing transformation based on amplitude and phase.

Therefore, the transformation layer TL according to the embodiment may use a plurality of transformation methods in accordance with properties of input complex data. For example, the transformation layer TL according to the embodiment may select the above described real-part/imaginary-part method, amplitude/phase method, combined method in which the real-part/imaginary-part method and the amplitude/phase method are combined, or N-division phase method in which amplitude is divided on the basis of a phase value.

As described above, the neural network NN0 according to the embodiment includes the complex-valued type 1 neural network NN1, and the real-valued type 2 neural network NN2. Therefore, in order to secure consistency of learning, it is necessary to properly transmit error information calculated in the type 2 neural network NN2 to the type 1 neural network NN1 via the transformation layer TL. Accordingly, the transformation layer TL according to the embodiment has a function of transforming the error information in the type 2 neural network into a form of error information in the complex-valued network, and propagating the transformed error information backward to the type 1 neural network.

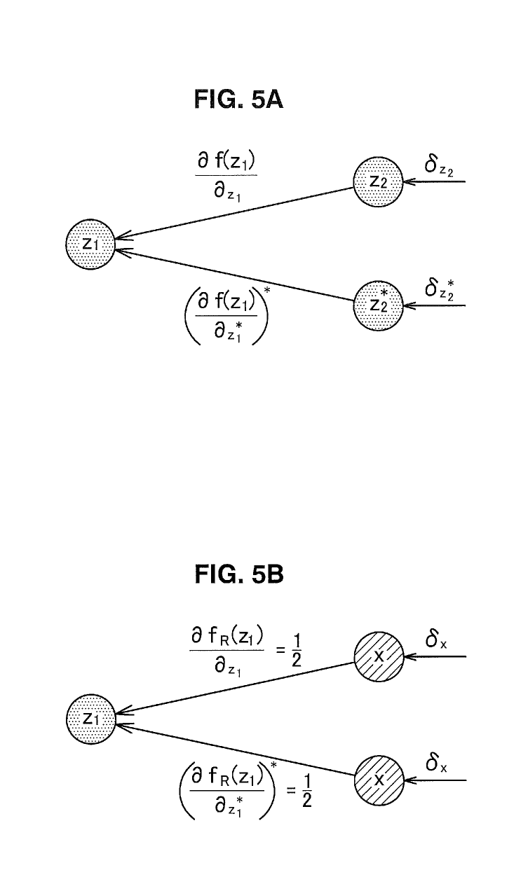

In this case, the transformation layer TL according to the embodiment may adopt the backward propagation of errors based on Wirtinger derivatives. FIGS. 5A and 5B are each an explanatory diagram illustrating the backward propagation of errors based on Wirtinger derivatives. FIG. 5A illustrates complex-valued neurons z₁ and z₂ that perform forward propagation by using a function f. The complex-valued neuron z₂ is represented as z₂=f(z₁). In the backward propagation in the complex-valued network illustrated in FIG. 5A, differentiation with respect to complex conjugation z₁^{*}, should be considered in addition to differentiation of z₁. Therefore, the neuron branches in two. In this case, error gradient δz₁ can be obtained from the following equation (3), where δz₁ represents error gradient that propagates backward such as error gradient from z₂ to z₁, and δz₂ and δz₂^{*} each represent error gradient from an upper layer of δz₂ and δz₂^{*}.

$${δ}_{{z}_{1}} = \frac{\partial f ( {z}_{1} )}{\partial {z}_{1}} {δ}_{{z}_{2}} + {( \frac{\partial f ( {z}_{1} )}{\partial {z}_{1}^{*}} )}^{*} {δ}_{{z}_{2}^{*}} \qquad ( 3 )$$

It is possible to extract a real part from a complex number by using a function f_{R} that transforms the complex number into a real number. The following equations (4) and (5) represent the function f_{R} and the extraction of the real part using the function f_{R}.

$$\begin{matrix}{f}_{R} ( z ) = \frac{z + {z}^{*}}{2} & ( 4 ) \\ {f}_{R} ( z = x + iy ) = x & ( 5 )\end{matrix}$$

In this case, x=x^{*} can be obtained when the transformation is applied to the backward propagation illustrated in FIG. 5A where δₓ represents error gradient from an upper layer of a real-valued neuron x illustrated in FIG. 5B. Accordingly, error gradient δz₁ can be obtained from the following equation (6).

$${δ}_{{z}_{1}} = \frac{\partial {f}_{R} ( {z}_{1} )}{\partial {z}_{1}} {δ}_{x} + {( \frac{\partial {f}_{R} ( {z}_{1} )}{\partial {z}_{1}^{*}} )}^{*} {δ}_{x} = {δ}_{x} \qquad ( 6 )$$

The backward propagation of the error information according to the embodiment has been described above. As described above, the transformation layer TL according to the embodiment achieves the forward propagation and the backward propagation between the type 1 neural network NN1 and the type 2 neural network NN2. Next, details of the forward propagation and the backward propagation according to each of the transformation methods that the transformation layer TL uses will be described.

### (Real-Part/Imaginary-Part Method)

First, the real-part/imaginary-part method according to the embodiment will be described. The transformation layer TL according to the embodiment may divide output of a complex-valued neuron on the basis of a real part and an imaginary part, and transform the output into a dimension corresponding to input of a real-valued neuron. As described above, the real-part/imaginary-part method according to the embodiment is particularly effective for data in which significance is attached to closeness to a real part or an imaginary part.

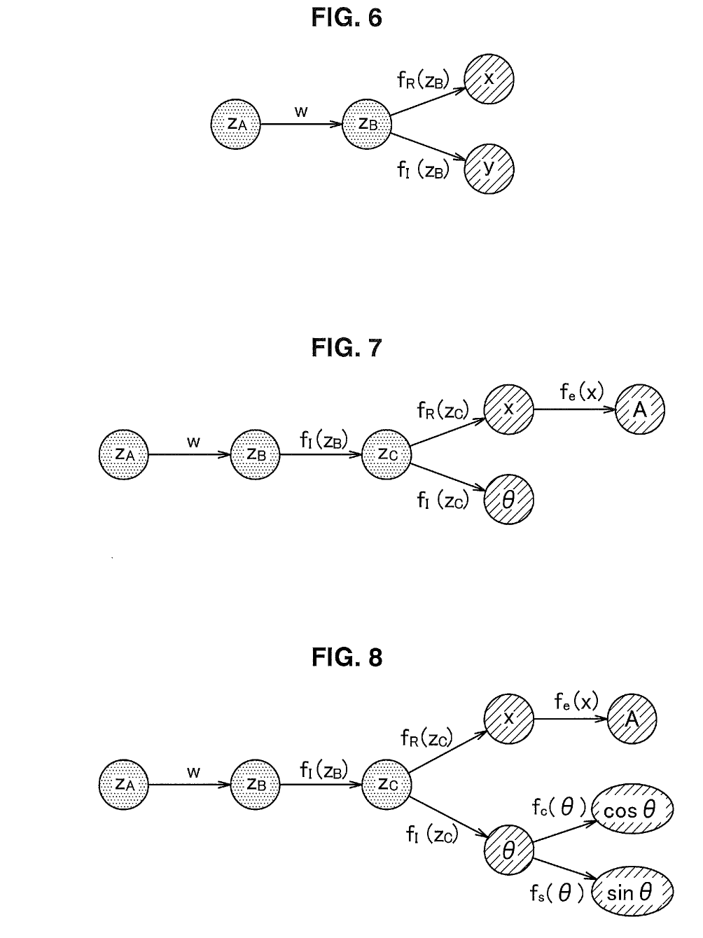

FIG. 6 is an explanatory diagram illustrating transformation of input/output of neurons according to the real-part/imaginary-part method according to the embodiment. As illustrated in FIG. 6, it is possible for the transformation layer TL according to the embodiment to transform output of z_{B}(=Wz_{A}) into dimensions corresponding to input of real-valued neurons x and y in the type 2 neural network. The output of z_{B}(=Wz_{A}) is obtained by multiplying output of a complex-valued neuron z_{A} in the type 1 neural network NN1 by a complex weight w, where z_{B}=x+iy.

In this case, in the forward propagation, the transformation layer TL according to the embodiment may transform the output of the complex-valued neuron into the dimensions corresponding to the input of the real-valued neurons by using the function f_{R} that extracts a real part and the function f_{I} that extracts an imaginary part. The following equations (7) and (8) respectively represent the function f_{R} and the function f_{I}.

$$\begin{matrix}{f}_{R} ( {z}_{B} ) = \frac{1}{2} ( {z}_{B} + {z}_{B}^{*} ) = x & ( 7 ) \\ {f}_{I} ( {z}_{B} ) = \frac{{z}_{B} - {z}_{B}^{*}}{2 i} = y & ( 8 )\end{matrix}$$

On the other hand, in the backward propagation, the following equation (9) represents an update amount Δw of the complex weight w, where δₓ represents error gradient propagated from the real-valued neuron x, and δ_{y} represents error gradient propagated from the real-valued neuron y. The following equations (10) represent a partial derivative in this case.

$$\begin{matrix}Δ w = \frac{\partial {z}_{B}}{\partial w} ( [ \frac{\partial {f}_{B}}{\partial {z}_{B}} + {( \frac{\partial {f}_{R}}{\partial {z}_{B}^{*}} )}^{*} ] {δ}_{x} + [ \frac{\partial {f}_{I}}{\partial {z}_{B}} + {( \frac{\partial {f}_{I}}{\partial {z}_{B}^{*}} )}^{*} ] {δ}_{y} ) & ( 9 ) \\ \frac{\partial {z}_{B}}{\partial w} = {z}_{A} , \frac{\partial {f}_{R}}{\partial {z}_{B}} = {( \frac{\partial {f}_{R}}{\partial {z}_{B}^{*}} )}^{*} = \frac{1}{2} , \frac{\partial {f}_{I}}{\partial {z}_{B}} = - \frac{1}{2} i , \frac{\partial {f}_{I}}{\partial {z}_{B}^{*}} = \frac{1}{2} i & ( 10 )\end{matrix}$$

As described above, by using the equation (9), the transformation layer TL according to the embodiment can propagate the error information in the type 2 neural network NN2 to the weight in the type 1 neural network NN1.

### (Amplitude/Phase Method)

Next, the amplitude/phase method according to the embodiment will be described. The transformation layer TL according to the embodiment may divide output of a complex-valued neuron on the basis of amplitude and phase, and transform the output into a dimension corresponding to input of a real-valued neuron. As described above, the amplitude/phase method according to the embodiment is particularly effective for data in which significance is not attached to a specific phase direction.

FIG. 7 is an explanatory diagram illustrating transformation of input/output of neurons according to the amplitude/phase method according to the embodiment. As illustrated in FIG. 7, it is possible for the transformation layer TL according to the embodiment to transform output of a complex-valued neuron z_{C} in the type 1 neural network NN1 into input of a real-valued neuron A corresponding to amplitude and input of a real-valued neuron θ corresponding to phase.

In this case, in the forward propagation, the transformation layer TL according to the embodiment may transform the output of the complex-valued neuron into dimensions corresponding to the input of the real-valued neurons by using a complex logarithm function f_{I} that transforms output of z_{B} into input of z_{C}, the functions f_{R} and f_{I} that are used in the real-part/imaginary-part method, and an exponential function fₑ that transforms output of x corresponding to a real part into input of A corresponding to amplitude. The following equations (11) and (12) respectively represent the complex logarithm function f_{I} and the exponential function fₑ.

f_{I}(Z_{B})=log(Z_{B}=Ae^{iθ})=log A+iθ (11)

fₑ(x)=e^{x} (12)

On the other hand, in the backward propagation, the following equation (13) represents an update amount Δw of the complex weight w, where δ_{A} represents error gradient propagated from the real-valued neuron A, and δ_{θ} represents error gradient propagated from the real-valued neuron θ. The following equations (14) represent a partial derivative in this case.

$$\begin{matrix}Δ w = \frac{\partial {z}_{B}}{\partial w} \frac{\partial {f}_{I}}{\partial {z}_{B}} ( [ \frac{\partial {f}_{R}}{\partial {z}_{C}} + {( \frac{\partial {f}_{R}}{\partial {z}_{C}^{*}} )}^{*} ] \frac{\partial {f}_{ɛ}}{\partial x} {δ}_{A} + [ \frac{\partial {f}_{I}}{\partial {z}_{C}} + {( \frac{\partial {f}_{I}}{\partial {z}_{C}^{*}} )}^{*} ] {δ}_{θ} ) & ( 13 ) \\ \frac{\partial {z}_{B}}{\partial w} = {z}_{A} , \frac{\partial {f}_{I}}{\partial {z}_{B}} = \frac{1}{{z}_{B}} , \frac{\partial {f}_{R}}{\partial {z}_{C}} = {( \frac{\partial {f}_{R}}{\partial {z}_{C}^{*}} )}^{*} = \frac{1}{2} , \frac{\partial {f}_{I}}{\partial {z}_{C}} = {( \frac{\partial {f}_{I}}{\partial {z}_{C}^{*}} )}^{*} = - \frac{1}{2} i , \frac{\partial {f}_{R}}{\partial x} = {e}^{x} & ( 14 )\end{matrix}$$

As described above, by using the equation (13), the transformation layer TL according to the embodiment can propagate the error information in the type 2 neural network NN2 to the weight in the type 1 neural network NN1.

### (Combined Method)

Next, the combined method according to the embodiment will be described. The combined method according to the embodiment may be a method in which the real-part/imaginary-part method and the amplitude/phase method are combined. Specifically, it is possible for the transformation layer TL according to the embodiment to further divide output of a real-valued neuron corresponding to phase transformed in accordance with the amplitude/phase method, into input of real-valued neurons corresponding to a sine wave and a cosine wave. Therefore, the combined method according to the embodiment is particularly effective for data in which significance is attached to closeness to a real part or an imaginary part and magnitude of amplitude at that time.

FIG. 8 is an explanatory diagram illustrating transformation of input/output of neurons on the basis of the combined method according to the embodiment. As illustrated in FIG. 8, it is possible for the transformation layer TL according to the embodiment to perform transformation similar to the amplitude/phase method and then further divide output of a real-valued neuron θ corresponding to phase into input of real-valued neurons sin θ and cos θ corresponding to a sine wave and a cosine wave.

In this case, in the forward propagation, the transformation layer TL according to the embodiment can perform the above described transformation by using a sine wave function fₛ and a cosine wave function f_{c}. The following equations (15) and (16) represent the sine wave function fₛ and the cosine wave function f_{c}.

fₛ(θ)=sin θ (15)

f_{c}(θ)=cos θ (16)

On the other hand, in the backward propagation, the following equation (17) represents an update amount Δw of a complex weight w, where δ_{A} represents error gradient propagated from the real-valued neuron A, and δₛ and δₛ represent error gradient propagated from the real-valued neurons sin θ and cos θ. The following equations (18) represent a partial derivative in this case.

$$\begin{matrix}Δ w = \frac{\partial {z}_{B}}{\partial w} \frac{\partial {f}_{I} ( {z}_{B} )}{\partial {z}_{B}} ( [ \frac{\partial {f}_{R}}{\partial {z}_{C}} + {( \frac{\partial {f}_{R}}{\partial {z}_{C}^{*}} )}^{*} ] \frac{\partial {f}_{e}}{\partial x} {δ}_{A} + [ \frac{\partial {f}_{1}}{\partial {z}_{C}} + {( \frac{\partial {f}_{I}}{\partial {z}_{C}^{*}} )}^{*} ] ( \frac{\partial {f}_{e}}{\partial θ} {δ}_{c} + \frac{\partial {f}_{x}}{\partial θ} {δ}_{r} ) ) & ( 17 ) \\ \frac{\partial {z}_{B}}{\partial w} = {z}_{A} , \frac{\partial log ( {z}_{B} )}{\partial {z}_{B}} = \frac{1}{{z}_{B}} , \frac{\partial {f}_{R}}{\partial {z}_{C}} = {( \frac{\partial {f}_{R}}{\partial {z}_{C}^{*}} )}^{*} = \frac{1}{2} , \frac{\partial {f}_{1}}{\partial {z}_{C}} = {( \frac{\partial {f}_{I}}{\partial {z}_{C}^{*}} )}^{*} = - \frac{1}{2} i , \frac{\partial {f}_{e}}{\partial x} = {e}^{*} , \frac{\partial {f}_{e}}{\partial θ} = - sin θ , \frac{\partial {f}_{1}}{\partial θ} = cos θ & ( 18 )\end{matrix}$$

As described above, by using the equation (17), the transformation layer TL according to the embodiment can propagate the error information in the type 2 neural network NN2 to the weight in the type 1 neural network NN1.

### (N-Division Phase Method)

Next, the N-division phase method according to the embodiment will be described. In the case of using the N-division phase method according to the embodiment, the transformation layer TL can decide the number of divided real-valued neurons corresponding to amplitude on the basis of a phase value of a complex-valued neuron z_{B}. The N-division phase method according to the embodiment is particularly effective for data in which significance is attached to a specific phase direction.

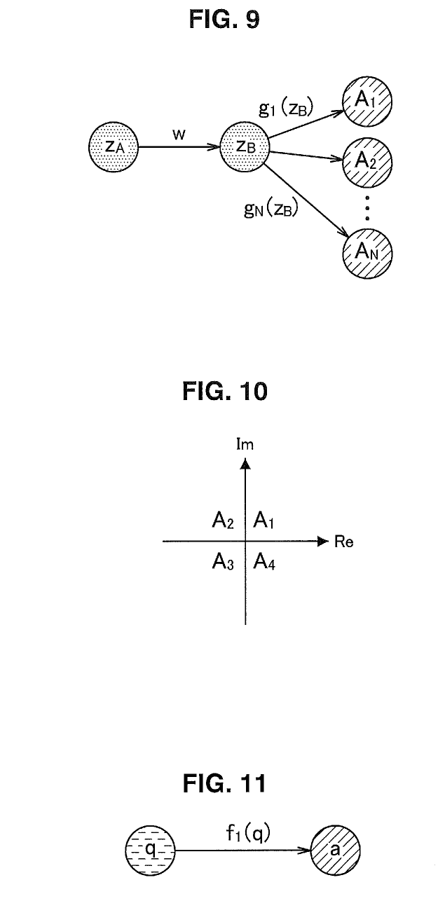

FIG. 9 is an explanatory diagram illustrating transformation of input/output of neurons according to the N-division phase method according to the embodiment. As illustrated in FIG. 9, it is possible for the transformation layer TL according to the embodiment to transform output of a complex-valued neuron z_{B} into dimensions corresponding to input of a plurality of real-valued neurons Aₙ(n=1, . . . , N) corresponding to amplitude.

In this case, in the forward propagation, the transformation layer TL according to the embodiment may decide input of an n-th real-valued neuron Aₙ by using a division function represented by the following equation (19) in a case of transforming output of a complex-valued neuron z_{B}=Ae^{iθ} into dimensions corresponding to input of N number of real-valued neurons, where θₛ represents a given initial phase (0≦θₛ≦2π). FIG. 10 illustrates divided regions in a case where N=4 and θₛ=0.

$${A}_{n} = {g}_{n} ( {z}_{B} ) = \{ \begin{matrix}{f}_{e} ( {f}_{R} ( {f}_{I} ( {z}_{B} ) ) ) = A & if \frac{2 π ( n - 1 )}{N} \leq θ + {θ}_{s} < \frac{2 π n}{N} \\ 0 & others\end{matrix} \qquad ( 19 )$$

On the other hand, in the backward propagation, the following equation (20) represents an update amount Δw of a complex weight w, where δ_{An} represents error gradient propagated from the real-valued neuron Aₙ. In this case, the following equation (21) represents a partial derivative δfₙ/δz_{B}, and δfₙ/δz_{B}=0 with regard to a neuron other than a neuron satisfying the condition.

$$\begin{matrix}Δ w = \frac{\partial {z}_{B}}{\partial w} {\sum }_{n = 1}^{N} \frac{\partial {f}_{n}}{\partial {z}_{B}} δ {A}_{n} & ( 20 ) \\ \frac{\partial {f}_{n}}{\partial {z}_{B}} = \frac{\partial {f}_{I}}{\partial {z}_{B}} [ \frac{\partial {f}_{R}}{\partial {z}_{B}} + {( \frac{\partial {f}_{R}}{\partial {z}_{B}^{*}} )}^{*} ] \frac{\partial {f}_{e}}{\partial {A}_{n}} & ( 21 )\end{matrix}$$

As described above, by using the equation (20), the transformation layer TL according to the embodiment can propagate the error information in the type 2 neural network NN2 to the weight in the type 1 neural network NN1.

### (Transformation of Input/Output of Hypercomplex-Valued Neuron)

Next, transformation of input/output of a hypercomplex-valued neuron according to the embodiment will be described. In the above paragraphs, the case in which the transformation layer TL according to the embodiment transforms output of the complex-valued neuron in the type 1 neural network NN1 into the dimensions corresponding to input of the real-valued neurons in the type 2 neural network NN2 has been described as a main topic. In addition, it is also possible for the transform layer TL according to the embodiment to transform input/output with regard to a hypercomplex-valued neuron. For example, the transformation layer TL according to the embodiment may transform output of a quaternion neuron in the type 1 neural network NN1 into a dimension corresponding to input of a real-valued neuron in the type 2 neural network NN2.

FIG. 11 is an explanatory diagram illustrating transformation of input/output of a hypercomplex-valued neuron according to the embodiment. FIG. 11 illustrates an example in which the transformation layer TL according to the embodiment transforms output of a quaternion neuron q into a dimension corresponding to input of a real-valued neuron a by using a function f₁. Here, for example, the quaternion neuron q can be represented as q=a+bi+cj+dk. In this equation, i, j, and k are imaginary units.

In this case, the transformation layer TL according to the embodiment can transform the output of the quaternion neuron q into the dimension corresponding to the input of the real-valued neuron a by using the function f₁ or a function f₂. The function f₁ extracts a real part by using q^{*}(q^{*}=a−bi−cj−dk) that is a conjugate quaternion of q. The function f₂ extracts a norm. The following equations (22) and (23) respectively represent the function f₁ and t the function f₂.

$$\begin{matrix}{f}_{1} ( q ) = \frac{q + {q}^{*}}{2} = a & ( 22 ) \\ {f}_{2} ( q ) = \sqrt{{qq}^{*}} = \sqrt{{a}^{2} + {b}^{2} + {c}^{2} + {d}^{2}} & ( 23 )\end{matrix}$$

As described above, it is possible for the transform layer TL according to the embodiment to transform output into a dimension corresponding to input of a hypercomplex-valued neuron by using the function that maps a hypercomplex number to a real number, in a way similar to the case of the complex-valued neuron.

### <<1.4. Connection Patterns of Transformed Neurons>>

Next, connection patterns of transformed neurons according to the embodiment will be described. In the above paragraphs, the transformation layers TL according to the embodiment that may select a plurality of method for transforming input/output of neurons have been described. In a similar way, it is possible to select a connection pattern of transformed real-valued neurons from among a plurality of methods in the type 2 neural network NN2 according to the embodiment. The type 2 neural network NN2 according to the embodiment may adopt a full connection pattern, a separate connection pattern, or a partial and separate connection pattern as the connection pattern of the real-valued neurons, for example.

### (Full Connection Pattern)

First, the full connection pattern according to the embodiment will be described. FIG. 12 is an explanatory diagram illustrating the full connection pattern according to the embodiment. In FIG. 12, two complex-valued neurons hatched with dots are illustrated in the left column. As described above, it is possible for the transformation layer TL according to the embodiment to transform output of the complex-valued neurons into dimensions corresponding to input of real-valued neurons. In the middle column in FIG. 12, four real-valued neurons hatched with solid lines are illustrated. The four real-valued neurons have been transformed via the transformation layer TL. In this case, as illustrated in FIG. 12, all of the transformed real-valued neurons may be connected in a next layer in the type 2 neural network NN2 according to the embodiment. In FIG. 12, the four real-valued neurons transformed from the complex-valued neurons are fully connected with four real-valued neurons in the next layer.

### (Separate Connection Pattern)

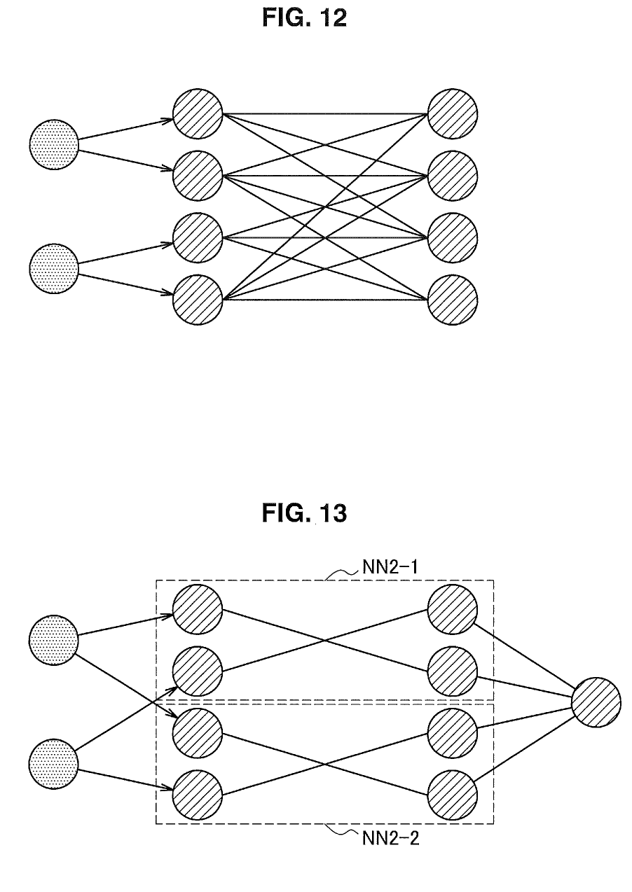

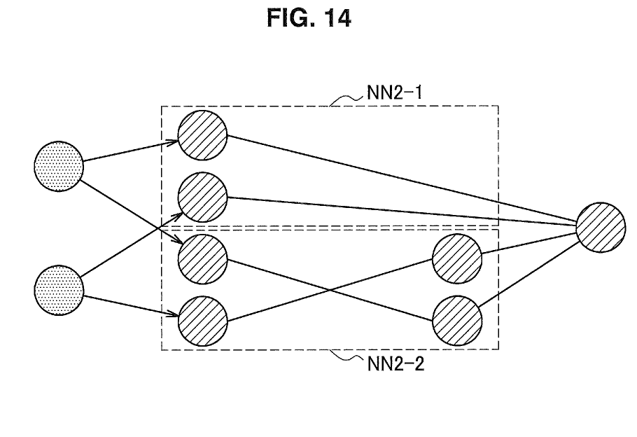

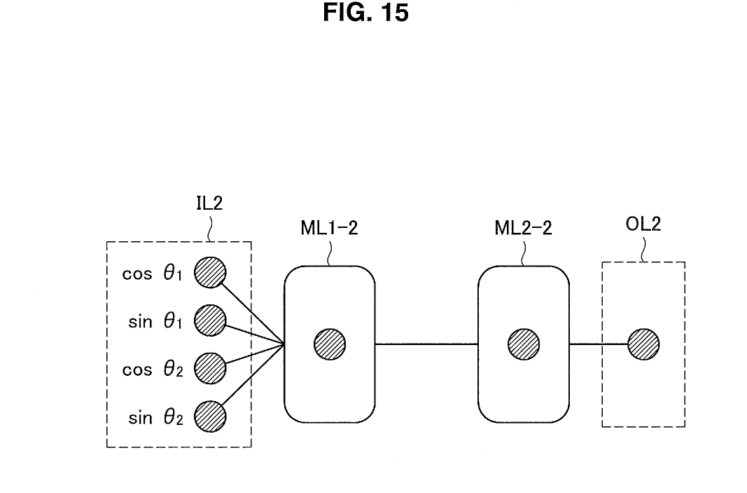

Next, the separate connection pattern according to the embodiment will be described. FIG. 13 is an explanatory diagram illustrating the separate connection pattern according to the embodiment. In a way similar to FIG. 12, input of four real-valued neurons that have been transformed from output of two complex-valued neurons are illustrated in the middle column in FIG. 13. On the other hand, in contrast to FIG. 12, output of the transformed real-valued neurons in the separate connection pattern illustrated in FIG. 13 may be separated into amplitude/phase, learning may be progressed, and then the neurons may be connected. FIG. 13 illustrates a type 2 neural network NN2-1 related to amplitude, and a type 2 neural network NN2-2 related to phase. As described above, it is possible to separate the learning in accordance with properties of real data in the separate connection pattern according to the embodiment. The separate connection pattern according to the embodiment is particularly effective for data in which significance is attached to amplitude or phase independently.

### (Partial and Separate Connection Pattern)

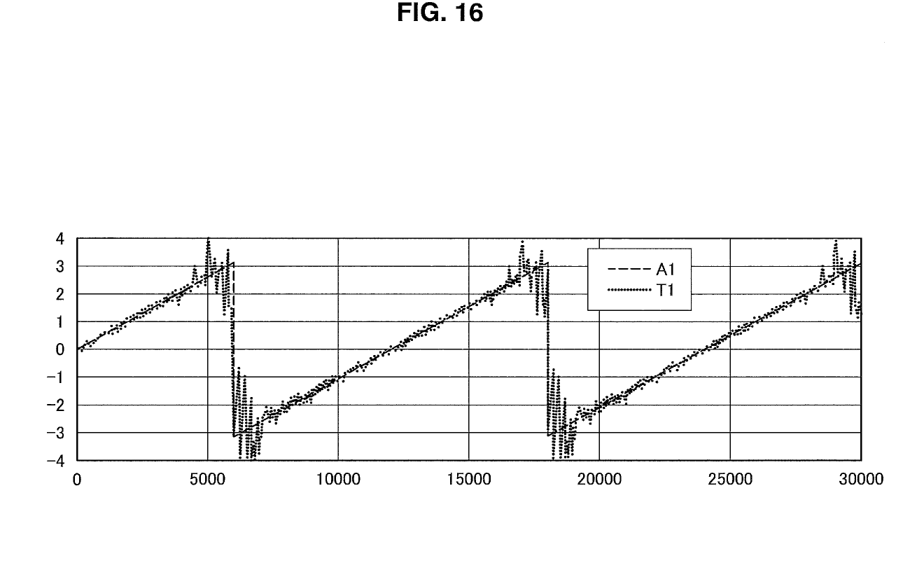

Next, the partial and separate connection pattern according to the embodiment will be described. FIG. 14 is an explanatory diagram illustrating the partial and separate connection pattern according to the embodiment. In a way similar to FIG. 13, FIG. 14 illustrates the type 2 neural network NN2-1 related to amplitude, and the type 2 neural network NN2-2 related to phase. In the partial and separate connection pattern illustrated in FIG. 14, the type 2 neural network NN2-1 related to amplitude and the type 2 neural network NN2-2 related to phase have different connection levels from each other with regard to real-valued neurons. In other words, it is possible to perform learning at various connection levels in accordance with properties of real data by using the partial and separate connection pattern according to the embodiment. For example, a connection level in which only phase is more abstracted may be configured in the partial and separate connection pattern according to the embodiment. By using the partial and separate connection pattern according to the embodiment, it is possible to achieve abstraction according to properties of real data.

### <<1.5. Effects According to Embodiment>>

Next, the effects according to the embodiment will be described. As described above, the neural network NN0 according to the embodiment includes the type 1 neural network NN1, the type 2 neural network NN2, and the transformation layer TL that connects the these two neural network. By using the neural network NN0 according to the embodiment, it is possible to simultaneously perform learning of complex data and real data. Thereby, improvement of estimation accuracy is expected.

On the other hand, it is also possible for a conventional real-valued neural network to perform a process based on complex data by dividing the complex data. However, in this case, the complex data is merely treated as a two-dimensional vector. Therefore, for example, it is difficult to perform learning such as phase rotation. Accordingly, deterioration in estimation accuracy is expected in the case where the process based on complex data is performed in the conventional real-valued neural network.

To verify the above expectations, the estimation accuracy is compared between the neural network NN0 according to the embodiment and a conventional real-valued neural network. Hereinafter, a comparison result of the estimation accuracy in phase difference learning will be described with regard to two signals having different frequency. In this verification, 30000 samples have been used as training data and test data, respectively. As the training data, two signals with frequency of 6.5 Hz and 4.5 Hz have been used. As teacher data, phase difference calculated from the two signals has been used. As the test data, two signals with frequency of 5.5 Hz and 5.0 Hz have been used. As correct answer data, phase difference calculated from the two signals has been used.

For the verification, the neural network NN0 having the configuration illustrated in FIG. 1 is used. In this case, two complex-valued neurons have been used in the input layer IL, 50 complex-valued neurons have been used in the middle layer ML1, and 100 real-valued neurons have been used in the middle layer ML2.

FIG. 15 illustrates a configuration of a comparative real-valued neural network. As illustrated in FIG. 15, the comparative real-valued neural network includes an input layer IL2, middle layers ML1-2 and ML2-2, and an output layer OL2. In this case, four real-valued neurons have been used in the input layer IL2, 100 real-valued neurons have been used in the middle layer ML1-2, and 100 real-valued neurons have been used in the middle layer ML2-2.

FIG. 16 is a diagram illustrating a result of phase difference learning using the conventional real-valued neural network. In FIG. 16, a dashed line indicates correct answer data A1, and a dotted line indicates test data T1. In addition, in FIG. 16, a vertical axis represents phase difference, and a horizontal axis represents time (sample). As illustrated in FIG. 16, fluctuation is conspicuous at phase ends in accordance with the learning result using the conventional real-valued neural network.

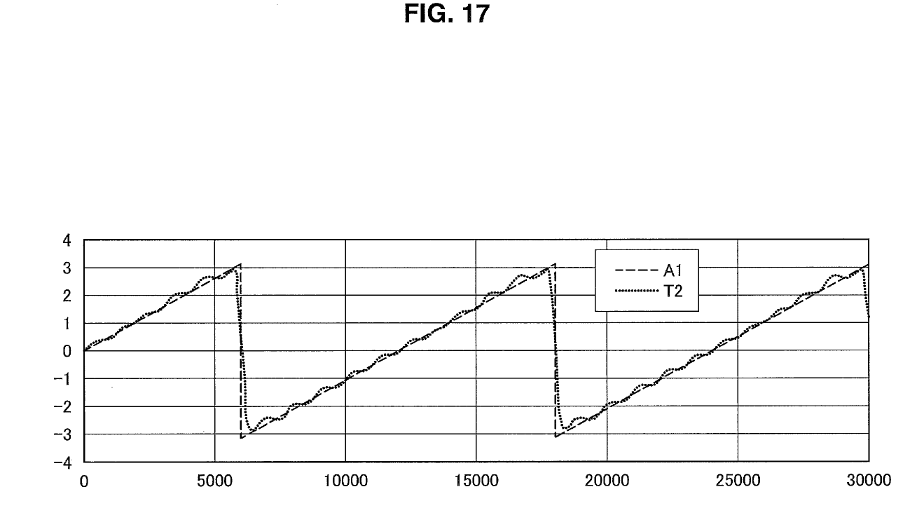

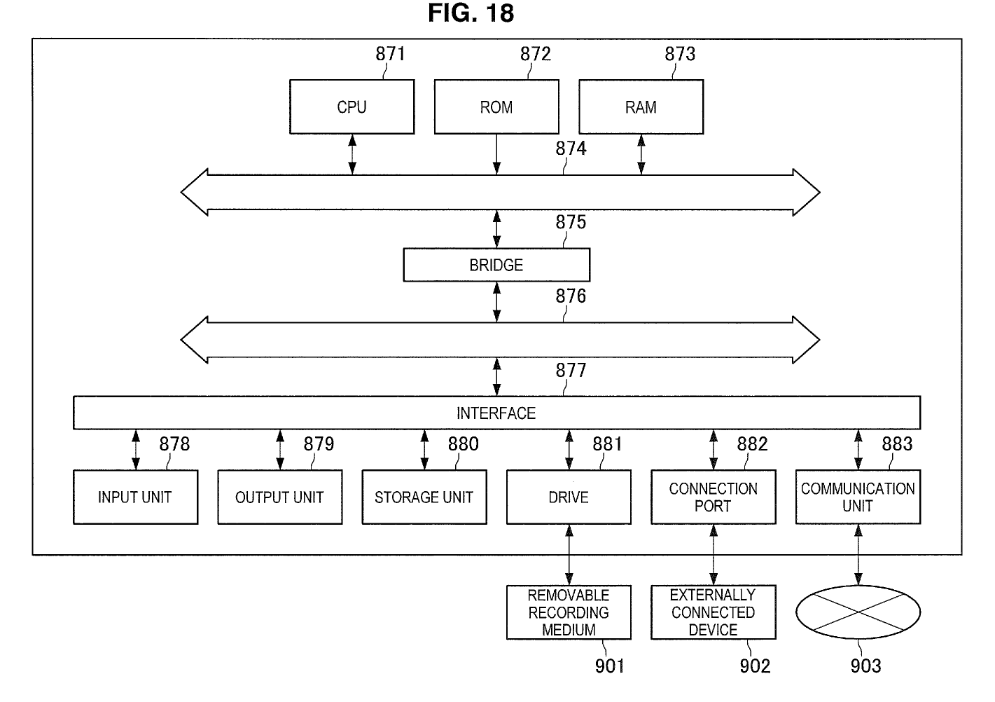

On the other hand, FIG. 17 is a diagram illustrating a result of phase difference learning using the neural network NN0 according to the embodiment. In FIG. 17, a dashed line indicates correct answer data A1, and a dotted line indicates test data T2. In a way similar to FIG. 16, a vertical axis represents phase difference, and a horizontal axis represents time (sample) in FIG. 17. As illustrated in FIG. 17, gentle phase shifting can be obtained especially at phase ends from the result of learning using the neural network NN0 according to the embodiment, in comparison with the result of learning using the conventional real-valued neural network. These results means that the neural network NN0 according to the embodiment perform estimation with high accuracy on the basis of properties of complex data such as phase wraparound.

### 2. Hardware Configuration Example

Next, a hardware configuration example of the information processing device 10 according to the embodiment of the present invention will be described. FIG. 18 is a block diagram illustrating the hardware configuration example of the information processing device 10 according to the present embodiment of the present invention. With reference to FIG. 18, for example, the information processing device 10 includes a CPU 871, a ROM 872, a RAM 873, a host bus 874, a bridge 875, an external bus 876, an interface 877, an input unit 878, an output unit 879, a storage unit 880, a drive 881, a connection port 882, and a communication unit 883. The hardware configuration illustrated here is an example. Some of the structural elements may be omitted. A structural element other than the structural elements illustrated here may be further added.

### (CPU 871)

The CPU 871 functions as an arithmetic processing device or a control device, for example, and controls entire operation or a part of the operation of each structural element on the basis of various programs recorded on the ROM 872, the RAM 873, the storage unit 880, or a removable recording medium 901.

### (ROM 872 and RAM 873)

The ROM 872 is a mechanism for storing, for example, a program to be loaded on the CPU 871 or data or the like used in an arithmetic operation. The RAM 873 temporarily or permanently stores, for example, a program to be loaded on the CPU 871 or various parameters or the like that arbitrarily changes in execution of the program.

### (Host Bus 874, Bridge 875, External Bus 876, and Interface 877)

The CPU 871, the ROM 872, and the RAM 873 are interconnected with each other, for example, via the host bus 874 capable of high-speed data transmission. In addition, the host bus 874 is connected, for example, via the bridge 875, with the external bus 876 in which a data transmission speed is comparatively low. In addition, the external bus 876 is connected with various structural elements via the interface 877.

### (Input Unit 878)

For example, as the input unit 878, a mouse, a keyboard, a touchscreen, a button, a switch, a microphone, a lever, or the like is used. As the input unit 878, a remote controller (hereinafter, referred to as remote) capable of transmitting a control signal by using infrared or other radio waves is sometimes used.

### (Output Unit 879)

The output unit 879 is, for example, a display device such as a cathode ray tube (CRT), an LCD, or an organic EL, an audio output device such as a speaker or headphones, a printer, a mobile phone, or a facsimile, that can visually or audibly notify a user of acquired information.

### (Storage Unit 880)

The storage unit 880 is a device for storing therein various types of data. As the storage unit 880, for example, a magnetic storage device such as a hard disk drive (HDD), a semiconductor storage device, an optical storage device, or a magneto-optical storage device is used.

### (Drive 881)

The drive 881 is a device for reading information recorded on the removable recording medium 901 and writing information to the removable recording medium 901. The removable recording medium 901 is, for example, a magnetic disk, an optical disk, a magneto-optical disk, or a semiconductor memory.

### (Removable Recording Medium 901)

The removable recording medium 901 is, for example, a DVD medium, a Blu-ray (registered trademark) medium, an HD-DVD medium, various types of semiconductor storage media, or the like. Of course, the removable recording medium 901 may be, for example, an electronic device or an IC card on which a non-contact IC chip is mounted.

### (Connection Port 882)

The connection port 882 is, for example, a port for connecting an externally connected device 902 such as a Universal Serial Bus (USB) port, an IEEE934 port, a Small Computer System Interface (SCSI), an RS-232C port, or an optical audio terminal.

### (Externally Connected Device 902)

The externally connected device 902 is, for example, a printer, a portable music player, a digital camera, a digital video camera, an IC recorder, or the like.

### (Communication Unit 883)

The communication unit 883 is a communication device used for a connection to a network 903. The communication unit 883 may be, for example, a communication card for a wired or wireless LAN, Bluetooth (registered trademark) or a wireless USB (WUSB), a rooter for optical communication, a rooter for an asymmetric digital subscriber line (ADSL), or a modem for various communication. The communication unit 883 may be connected with a telephone network such as an extension telephone line network or a mobile-phone service provider network.

### 3. Conclusion

As described above, the neural network NN0 according to the embodiment of the present invention includes the type 1 neural network NN1, the type 2 neural network NN2, and the transformation layer TL that connects these two neural networks. For example, the type 1 neural network NN1 may be a complex-valued neural network, and the type 2 neural network NN2 may be a real-valued neural network. In this case, the transformation layer TL according to the embodiment of the present invention can transform output of a complex-valued neuron in the type 1 neural network NN1 into a dimension corresponding to input of a real-valued neuron in the type 2 neural network NN2. In accordance with the above described configuration, it is possible to reduce a network size and calculation cost with regard to the neural network to which multidimensional data is input.

The preferred embodiment(s) of the present invention has/have been described above with reference to the accompanying drawings, whilst the present invention is not limited to the above examples. A person skilled in the art may find various alterations and modifications within the scope of the appended claims, and it should be understood that they will naturally come under the technical scope of the present invention.

What is claimed is:

1. An information processing device comprising:
an estimation unit configured to estimate a status by using a neural network constituted by single- or multi-dimensional neurons that perform output on the basis of input multidimensional data, wherein
the neural network includes a transformation layer configured to transform output of a type 1 neuron into a dimension corresponding to input of a type 2 neuron, and
the type 2 neuron performs a process based on lower-dimensional data than the type 1 neuron.

2. The information processing device according to claim 1, wherein
the type 1 neuron is a complex-valued neuron, and
the type 2 neuron is a real-valued neuron.

3. The information processing device according to claim 2,
wherein the neural network further includes
a complex-valued network constituted by at least one or more layers including an input layer to which complex data is input, and
a real-valued network constituted by at least one or more layers including an output layer to which real data is input, and
wherein the transformation layer connects the complex-valued network and the real-valued network.

4. The information processing device according to claim 3, wherein
the transformation layer propagates error information in the real-valued network backward to the complex-valued network.

5. The information processing device according to claim 2, wherein
the transformation layer divides output of the complex-valued neuron on the basis of a real part and an imaginary part, and transforms the output into a dimension corresponding to input of the real-valued neuron.

6. The information processing device according to claim 2, wherein
the transformation layer divides output of the complex-valued neuron on the basis of phase and amplitude, and transforms the output into a dimension corresponding to input of the real-valued neuron.

7. The information processing device according to claim 6, wherein,
on the basis of a sine wave and a cosine wave, the transformation layer further divides the output of the real-valued neuron that has been divided on the basis of phase, and transforms the output into a dimension corresponding to input of the real-valued neuron.

8. The information processing device according to claim 2, wherein,
the transformation layer decides the number of the real-valued neurons on the basis of phase.

9. An information processing method using a neural network constituted by single- or multi-dimensional neurons to which multidimensional data is input, the information processing method comprising:
transforming output of a type 1 neuron into a dimension corresponding to input of a type 2 neuron,
wherein, in the transformation, the type 2 neuron performs a process based on lower-dimensional data than the type 1 neuron.
